(19) United States
(12) Patent Application Publication
(10) Pub. No.: US 2002/0184533 A1
(43) Pub. Date: Dec. 5, 2002

(54) System and method for providing network security policy enforcement

(76) Inventor: Paul D. Fox, San Diego, CA (US)

Correspondence Address: OPPENHEIMER WOLFF & DONNELLY LLP, 840 NEWPORT CENTER DRIVE, SUITE 700, NEWPORT BEACH, CA, 92660, US

(21) Appl. No.: 10/159,316

(22) Filed: May 29, 2002

Related U.S. Application Data
(60) Provisional application No. 60/294,312, filed on May 30, 2001.

(51) Int. Cl. G06F 11/30; G06F 15/173

(52) U.S. Cl. 713/201; 709/224

(57) ABSTRACT

A rack-mountable, self-contained computer network security device that actively monitors a computer network's policy-defined configuration baseline for deviations. The device compares system identifying attributes and active TCP/UDP daemons to a policy baseline to determine policy compliance. Computer system events may be stored within a database.

### RELATED APPLICATIONS

The application claims priority of U.S. provisional application Serial No. 60/294,312 filed May 30, 2001, which is incorporated by reference in its entirety.

### FIELD OF THE INVENTION

The invention relates to a system and method for enforcing a network security policy. More particularly, the invention relates to a system and method for enforcing a network security policy by scanning computers connected to the network for current policy values and comparing the current policy values with predetermined policy values.

### BACKGROUND OF INVENTION

Computer network security is an important issue today. With the exponential growth of the Internet, the number of potential computer hackers to an organization has increased. The barrier of entry for a computer hacker to engage in informational warfare has become virtually non-existent. Computer hackers can range from a petty criminal to a hired, skilled hacker of an unfriendly organization. Computer hackers may desire goals from personal glorification to national/industrial espionage. Computer network attacks come in many forms such as web page defacement and confidential information theft/tampering.

One issue facing computer network security is the lack of a computer network policy. Organizations should define a computer network policy that provides a framework for the computer networks physical design and a guideline for computer network users. Computer networks are generally in a state of flux. Networked computer systems should have a computer policy. The network policy should clearly define which systems are allowed to be connected to the network during various conditions. The policy should identify the system's assigned tasks and be monitored for any deviations. In May of 2000, the SANS Institute published its “Top Ten Security Threats.” Nine of the ten threats pertained to Transmission Control Protocol/User Datagram Protocol (TCP/UDP) daemons. A fundamental rule is that a networked system should not run unneeded nor unused TCP/UDP daemons. The policy should therefore identify an allowed list of TCP/UDP daemons a system may run. Defining and adhering to a security baseline is a strong factor for computer network security. Identifying a computer network's architecture and functionality at any given time is a key element to its protection. Once non-compliance is determined, corrective measures may be taken to rectify the non-compliance.

Network administrators may apply various computer network software products as deemed appropriate to meet network requirements. Network administrators may be hampered in this task due to time constraints and effective storage of data. Typically, network administrators may not electronically store the policy compliance status of a network for future reference by the network administrator or other network user.

Computer network security policies apply to both networked systems and network users. The policy may state which computers are allowed to be connected to the network and which TCP/UDP services are allowed for each networked system. The network should be monitored for policy deviations by comparing stored policy values to the current policy values of the network. All results may be stored in a central location and be discernible to a network user.

One major problem facing computer network security is computer viruses. Many viruses are disseminated in electronic form as an electronic mail (e-mail) attachment which typically requires human intervention to execute. One virus known as the “ILUVYOU” virus has been estimated to have caused damages in excess of $6 billion worldwide. This figure may have been reduced if organizations were able to better educate their network users regarding network security.

Keeping abreast of network security issues may be difficult due to the constant discovery of new vulnerabilities. Network users should have the training and experience to independently make sound security decisions. One method of informing users of potential dangers is via e-mail. This is somewhat ineffective because a network administrator generally has no effective way to determine if the recipients have read the policy and are in compliance. A network user also should have a mechanism to inform the network administrator that the network user is in compliance. A network user's policy compliance level should be stored in the event of an investigation regarding the network compliance of the network user.

These and other drawbacks exist.

### SUMMARY OF THE INVENTION

The invention relates to a rack-mountable, self-contained computer network security device that actively monitors a computer network's policy-defined configuration baseline for deviations. A network administrator may access the device via the Hypertext Transfer Protocol/Secure Sockets Layer (HTTP/SSL). Policy compliance may be determined by actively scanning the network and comparing scan results to the policy defined baseline. If the scan results and policy baseline values match, the network is deemed to be compliant. If the scan results and policy baseline values do not match, however, the network is deemed non-policy compliant. All results may be stored in a database.

The invention may provide a central location for network users to determine an organization's security policy and increase the network user's computer network security knowledge. The invention may display the organization's computer network security policy. Network users may be notified via e-mail of organizational policy amendments. The e-mail message may include a Uniform Resource Locator (URL) to a web page that contains the policy amendments. Once a network user has read and acknowledged the policy amendment, the invention may store the network user's information.

### BRIEF DESCRIPTION OF THE DRAWINGS

FIG. 1A is a schematic block diagram of a method for scanning networked systems according to one embodiment of the invention.

FIG. 1B is a schematic block diagram of a method for scanning networked systems according to one embodiment of the invention.

FIG. 2 is a schematic block diagram of a method for scanning TCP/UDP ports according to one embodiment of the invention.

FIG. 3 is a schematic block diagram of a method for notifying network users of a network policy amendment according to one embodiment of the invention.

FIG. 4. is a schematic block diagram of a system for scanning networked systems according to one embodiment of the invention.

FIG. 5 is a schematic block diagram of a system for scanning TCP/UDP ports according to one embodiment of the invention.

FIG. 6 is a schematic block diagram of a method for notifying network users of a network policy amendment according to one embodiment of the invention.

FIG. 7 is a schematic block diagram of a method of determining whether a networked system complies with a network security policy according to one embodiment of the invention.

FIG. 8 is a schematic block diagram of a system for determining whether a networked system complies with a network security policy according to one embodiment of the invention.

### DETAILED DESCRIPTION OF THE INVENTION

The invention relates to a self-contained, rack mountable computer system that may be attached internally to an organization's Transmission Control Protocol/Internet Protocol (TCP/IP) computer network. The system may be accessed from a network user's computer using, for example, a standard web browser. Sensitive information may be encrypted between the system and the network user's web browser via the Secure Socket Layer (SSL). Access may be enabled on a password-based operational role. The system may actively scan the network to determine which computers, terminals, workstations, etc. connected to the network and the TCP/UDP services the computers are operating at any given time. Scan results may be compared to a computer network policy defined network configuration stored within a system database. Any discrepancies may be flagged such that the network user may identify non-policy compliant computers. The system may provide a central web-based location for organizations to post network security policy and promulgate policy amendments to network users.

The system may be a TCP/IP networked computer system contained in a 18″×12″×2″ metal chassis. System programs may be stored on a hard disk of, for example, 10 GB (or greater). The computer system preferably includes an operating system that supports the TCP/IP. The computer system may be accessed via a hypertext transfer protocol (HTTP) compliant web server. The computer system functions preferably are compiled C programs that are stored in the web server's Common Gateway Interface (CGI) directories. Operating system access may be provided through thy systems monitor and keyboard interface and/or 10/100BaseT Ethernet interface (e.g., Telnet and/or SSH protocols).

The computer system may use a list of IP addresses stored within a database to determine which computers to monitor. The network user may add, remove, and edit the list of IP addresses stored within the database. The computer system may not scan computers not provided with the list of IP addresses. Each IP address may be assigned system identifying attributes. These attributes may be dedicated by the network policy and may include: Domain Name Service (DNS) fully qualified domain name, netbios hostname, netbios user name, operating system, Media Access Control (MAC) address, machine type template, mission critical status, physical location, point of contact phone/e-mail address, and text description. A machine type template may be an array of TCP and UDP ports that are allowed to be active on a system.

The computer system may determine a networked computer's policy compliance using Network Discovery and TCP/UDP port scans. These scans may be initiated by a network user or scheduled to execute at predetermined times.

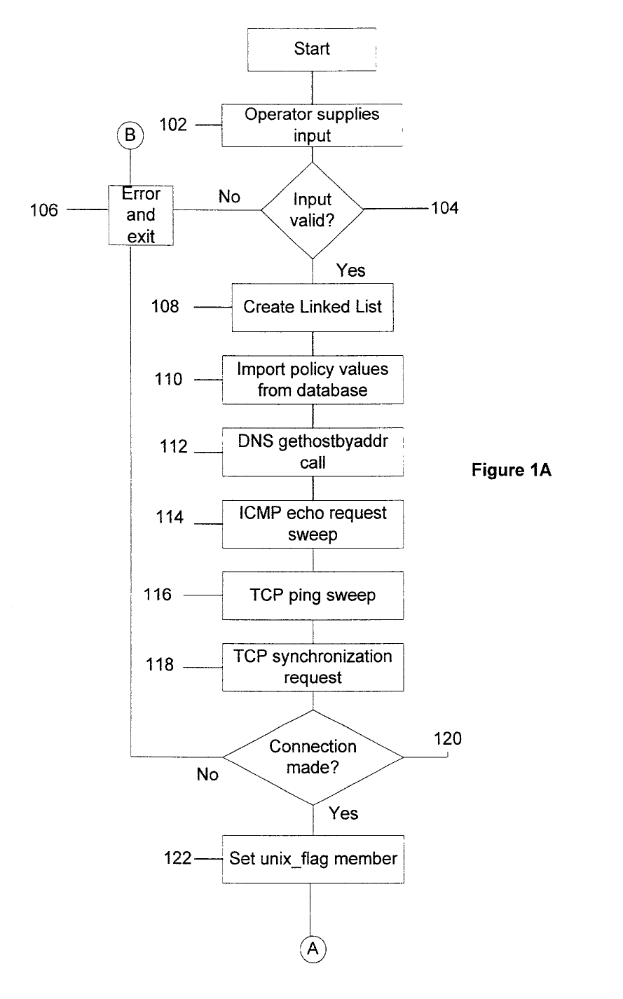

FIGS. 1A and 1B illustrate a method of scanning networked systems using the Network Discovery scan according to one embodiment of the invention. The Network Discovery scan may be a compiled C program located within the web server's CGI directory. The Network Discovery scan may scan the database for multiple IP addresses, subset IP addresses or a single IP address. The Network Discovery scan may use a network environment (e.g., HTML PUT, GET and command line) variables as arguments, step 102. The Network Discovery scan may determine if the input is valid, step 104. If the input is invalid, an error may be returned and the program may be exited, step 106. If, however, the input is valid, the Network Discovery scan may then create a linked list of information structures for each IP address, step 108. Each structure may contain fields for the policy defined and scan discovered values of each IP address' MAC address, DNS hostname, netbios hostname, user name, ICMP response, TCP ping response, and operating system type. The Network Discovery scan may insert the database stored policy defined values into each IP address' appropriate fields, step 110.

The Network Discovery scan may traverse the linked list and determine DNS defined hostnames registered to the IP addresses. This may be achieved by using the gethostbyaddr C function to query the network's domain name server, step 112. A fully-qualified domain name may be removed from the response and stored in the DNS hostname structure member.

An Internet Control Message Protocol (ICMP) echo request may be sent to each IP address within the linked list, step 114. The ICMP echo request may include packets that are sent out in a configurable burst rate. The values of the burst rate may be stored within the database and may be configurable to adjust to various networking environments. The packets may contain values for the number of packets to send in succession, retry attempts, and the time-out values in waiting for a response. These values may be configured via the computer system's network user's menu. The ICMP packets may be created via a RAW socket interface and have a padded payload to give the packet a size of 1024 bytes. Better throughput performance may be achieved using packets of this size. The ICMP packet's payload may be filled with, for example, the character string “NETFOX NETFOX NETFOX . . . . ” This may inform network monitoring devices that the ICMP packet originated from a NETFOX device.

A TCP ping may also be sent to determine if a network host is active. A TCP ping may be useful because a computer hacker may disable a computer's ability to respond to an ICMP echo request that may be detected. To identify the possibility of this occurrence, the computer system may send a TCP ping request to a TCP port 113 (authentication) and a second TCP ping request to a TCP port the user specifies, step 116. The computer system may traverse the linked list and send a TCP synchronization request to each IP address' authentication port and user specified TCP port, step 118. The host is active if a connection is created, step 120, or an error from the host is returned (e.g., ECONNREFUSESD error message), step 106. The method of ICMP=false and TCP=true may be used to determine potential “stowaways” on the monitored computer network. If a connection is established with the authentication port, a unix_flag member of the structure may be set, step 122. This may be used to determine the operating system of the networked computer.

The computer system may send netbios name service query request packets to the IP addresses within the linked list that responded to an ICMP request, TCP ping request or both, step 124. The netbios name service may run on a UDP port 137. A determination may be made regarding whether the queried system has transmitted a response, step 126. If the queried system transmits a response packet, the netbios hostname may be extracted, step 128. The name of a currently logged-on user and MAC address of the network interface card may be determined from the response packet, step 130. The IP address netbios_flag within the linked list of the responding system may be set, step 132.

The computer system may determine a networked system's operating system based upon the unix_flag and netbios_flag, step 134. The computer system may make an educated guess as to the type of operating system for each active IP address. The educated guess may be based on whether a system is running the authentication service. If the system is running the authentication service, the system may be considered to be a UNIX based system. If the system is not running the authentication service, the system may be considered to be a Microsoft based system if the netbios name service protocol is running. Otherwise, the operating system may be indeterminate.

Upon scan completion, the scan results may be imported to a database located on, for example, a hard disk and presented to the network user using web browser, step 136. Stored in the database along with the scan results may be scan information. Scan information may include when the scan started, completed, range of IP addresses scanned, and the network user's name who requested the scan. The results may be parsed into three different tables. The networked systems that responded to the ICMP echo requests may be considered to be an up known host. The up known hosts may then be presented to a network user in an up known hosts table that identifies the IP address for each up known host, step 138. Displayed next to each IP address may be a networked system's associated policy defined DNS hostname, netbios hostname, netbios username, operating system and MAC address. The scan discovered values may be presented adjacent the policy definitions. Any dissimilar values may be displayed in red. Another table may be titled “stowaway.” The “stowaway” table may be presented to a network user, step 140. The “stowaway” table may display the IP addresses that did not respond to ICMP echo requests but did respond to TCP ping requests. The policy defined values and the scan results may be displayed with the IP address. A third table may be titled down known hosts. The down known hosts table may be presented to a network user, step 142. Every networked system corresponding to an IP address listed in a table that did not respond to an ICMP echo request or TCP ping may be displayed in this table along with the associated policy defined system attributes.

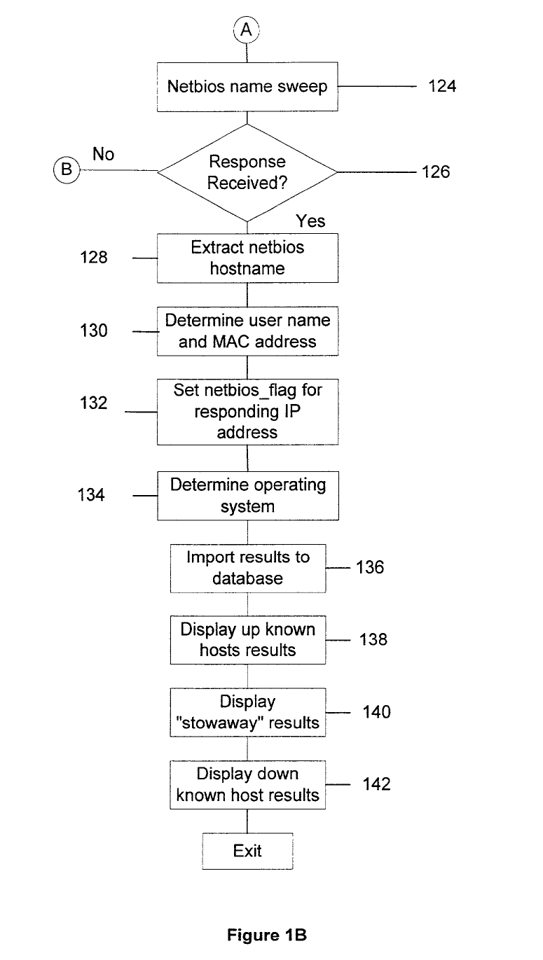

FIG. 2 illustrates a TCP/UDP port scanning method according to one embodiment of the invention. The TCP/UDP port scan may be a compiled C program located within the web server's CGI directory. The computer system may allow a network user to scan the complete IP address range, a subset of the IP address range or single IP address stored within a database. The scan's TCP/UDP port query range may be refined to include privileged ports (1-1023), the complete range of TCP/UDP ports (1-65355) or a users defined array of ports. The TCP/UDP port scan may use a network user's input environment (e.g. HTML PUT, GET and command line) variables as arguments, step 202. A determination may be made regarding whether the user input is valid, step 204. If the input is invalid, an error may be returned and the program may be exited, step 206.

The TCP/UDP port scan may create a linked list from the IP address range specified, step 208. Policy information may then be extracted from the database, step 210. An ICMP echo request may then be transmitted to a system corresponding to that IP address to determine if the IP address is active, step 212. A determination may be made regarding whether the system has responded to the ICMP request, step 214. If the system fails to respond to the ICMP echo request, a TCP ping may be sent to the system, step 216. A determination may then be made regarding whether the system has responded to either or both the ICMP request or the TCP ping, step 218. If the system responds to either the ICMP echo request or the TCP ping, the system may be scanned. Systems that do not respond to either request may not be scanned. Based on a the determination of step 218, the systems to be scanned may be set, step 220.

The TCP/UDP port scan may commence TCP port scanning for ports specified by the network user, step 222. The TCP/UDP port scan may use the RFC defined protocol for TCP communication establishment and termination. The TCP/UDP may attempt a TCP connection to every TCP port requested by the network user with every active system. Based upon the response from the scanned system, the query port may be deemed active or inactive. If the networked system's TCP service responds to the synchronization request with an ASCII text banner, the computer system copies the ASCII text banner into the database. If a system corresponding to an IP address fails to respond to multiple TCP synchronization attempts, the system may be considered inactive. This may occur when a system is running a personal firewall or other security software that modifies a system's network behavior. Scanning of the system may be stopped and the program may continue the scanning process with the next active IP address in the linked list.

When every active system has been TCP scanned, the TCP/UDP port scan may return to the beginning of the linked list to UDP port scan active systems, step 224. The TCP/UDP port scan may send a UDP packet to every query port of every active system. The UDP packet's payload may contain the character string “NETFOX NETFOX NETFOX . . . ” to elicit a response from the queried port. A UDP packet may be transmitted to each port of each scanned system, step 226. A determination may be made regarding which, if any, of the scanned systems have responded to the UDP packet, step 228. If the networked system's UDP service responds to the synchronization request with an ASCII text banner, the computer system copies the ASCII text banner into the database. The TCP/UDP port scan may terminate scanning a system if the number of UDP requests not responded to reaches a predefined limit. UDP ports that responded to UDP queries may be stored within the scan results. The TCP/UDP port scan may continue scanning with the next active IP address in the linked list, step 230.

When the UDP scan completes scanning active hosts from the linked list, all results may be imported into the database, step 232, and output to the network user's web browser, step 234. Stored in the database along with the scan results may be information concerning the completed scan. This information may include when the scan started, completed, range of IP addresses scanned, TCP/UDP ports queried, and the network user's name who requested the scan. The results may be parsed into two different tables. Systems that were scanned may be displayed in an up hosts table. Displayed along with every scanned system's IP address may be the scanned system's allowed TCP/UDP ports compared to scan discovered TCP/UDP ports. Scan found active TCP/UDP ports that do not match a system's allowed list of TCP/UDP (for example, defined by machine type template) may be displayed in red. Policy allowed TCP/UDP ports may be displayed in blue. This aids the network user in quickly determining policy compliance. Every port number may be linked to another web page that contains port specific information. The port's ASCII text banner and timestamp are displayed when applicable.

The computer system may allow the network users to view the previous results of network scans. The database may be searched to find all scan results based upon type of scan (Network Discovery or TCP/UDP Port scan), time, IP address range scanned, IP address, username, DNS name, netbios hostname, netbios username, MAC address, TCP/UDP port number, or other criteria. The results may be presented as a list of completed scan times and dates which may be hyper-text linked to actual scan results. Scan results may display the time the scan was executed, the network user who initiated the scan, type of scan, and the time required for the scan to complete.

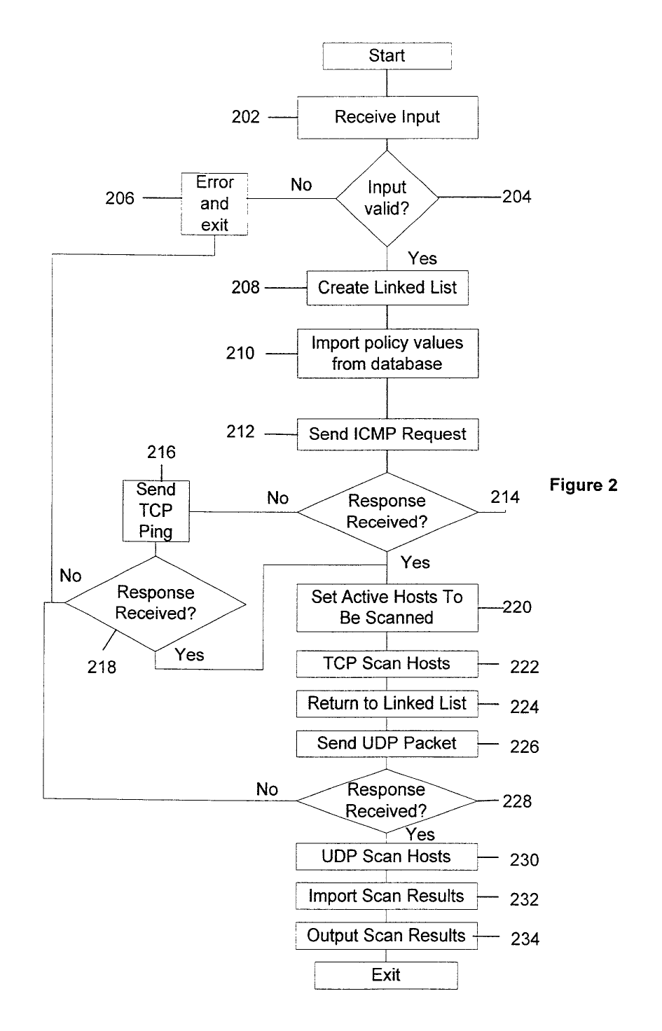

The computer system network user may create a policy revision to reflect a change in policy as shown in FIG. 3. The network user may formulate a new policy amendment, step 302. Upon completion, the network user may send, for example, an e-mail notification to the policy's intended recipients, step 304. If an e-mail notification is not sent, the policy may be stored in a modifiable form, step 306. If an e-mail notification is to be sent, the network user may select one or more intended recipients, step 308. A list of recipient's e-mail addresses may be stored within the computer system database. The computer system may create a Simple Mail Transfer Protocol (SMTP) based e-mail message. The SMTP e-mail message may be sent to every selected recipient, step 310. Contained in the e-mail message may be a URL that retrieves the newly created policy amendment from the computer system. The completed policy revision may be stored within the database. The network user may be unable to modify any policy amendment that has been sent via e-mail. If the network user does not send an e-mail message, the policy may be stored within the database for subsequent modification or deletion.

An e-mail recipient may receive an e-mail message from the computer system containing a URL for the computer system, step 312. The recipient may click on the URL, step 314, and a web browser window may open containing the revised policy, step 316. Upon reading the policy, the recipient may supply their name within a text field, step 318, and select an acknowledge button, step 320. The computer system may then determine the IP address for the computer being used by the recipient, computer DNS, netbios name, current user, MAC address and date, step 322. The results may then be stored in the database, step 324. The computer system may not acknowledge a network user's policy compliance unless the user's name is entered in the provided text field. Once the network user has acknowledged the policy amendment, a confirmation may be returned to the network user, step 326.

Every policy that has been sent may have a View Compliance link. The network user may select this link to determine which network users have read and complied with the policy amendment. If the IP address of the complying user's system is within the computer system database, the network user may view the contact information for the system. This allows the network user to quickly determine a network user's level of policy compliance.

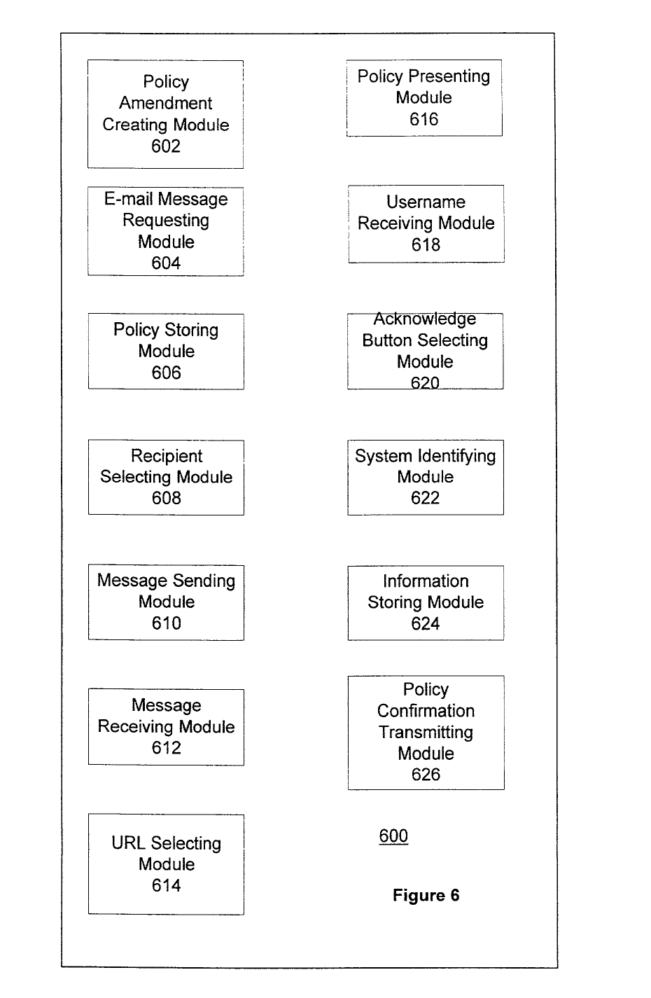

FIG. 7 illustrates an overall method of determining whether a networked system complies with a network security policy according to one embodiment of the invention. A system for determining whether the system is in compliance may be identified, step 12. The system may then be scanned, step 14. The system may be scanned for current network and/or system information such as, for example, netbios hostname, operating system, netbios username, IP address, etc. The current network and/or system information may be compared to network and/or system information stored for the system, step 16. Based on the comparison of current information and stored information, a determination may be made regarding whether the system complies with the network security policy, step 18.

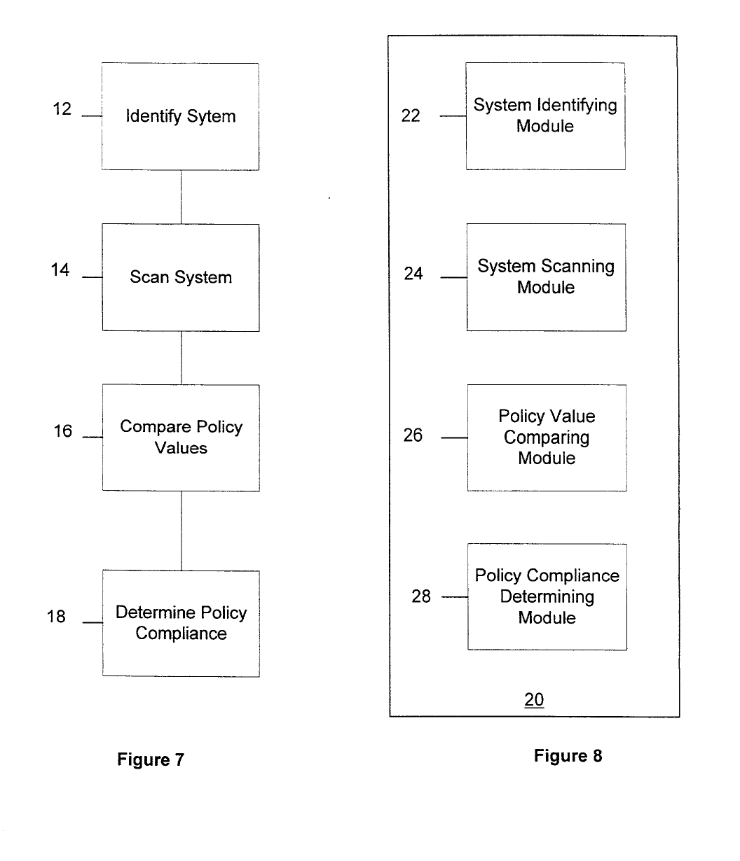

FIG. 8 illustrates a system 20 for determining whether a networked system complies with a network security policy according to one embodiment of the invention. The system 20 may include a system identifying module 22 that identifies one or more systems to determine whether the one or more systems comply with a network security policy. A system scanning module 24 may be used to scan the systems identified by system identifying module 22 for current network and/or system information such as, for example, netbios hostname, operating system, netbios username, IP address, etc. The current network and/or system information may be compared to network and/or system information stored for the system using, for example, policy value comparing module 26. Based on the comparison of current information and stored information, a determination may be made regarding whether the system complies with the network security policy using, for example, policy compliance determining module 28.

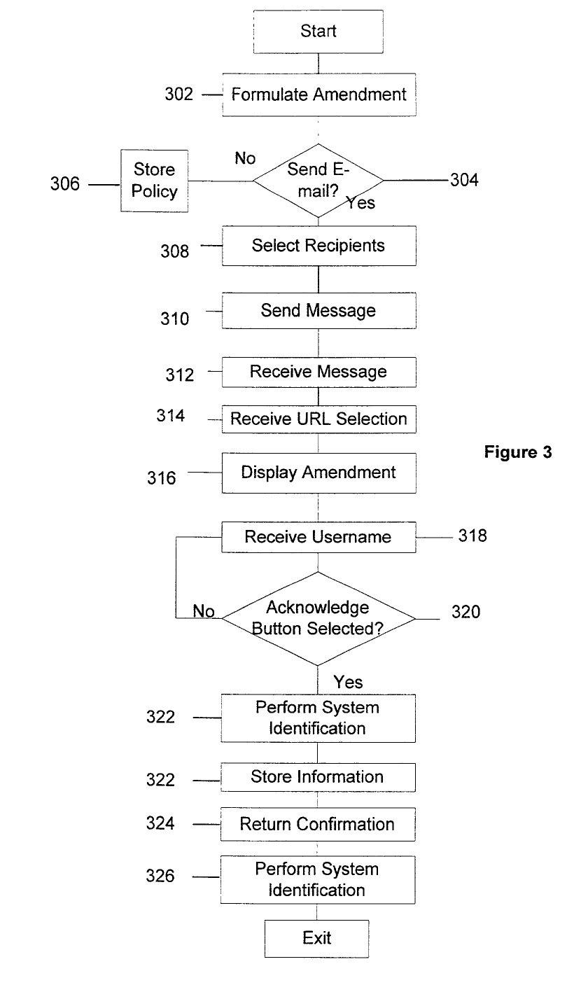

FIG. 4 illustrates a system 400 for scanning networked systems using a network discovery scan according one embodiment of the invention. The system 400 may include an input receiving module 402. The input receiving module 402 may enable a network user to input network environment variables (e.g., HTML PUT, GET, and command line) as arguments. An input validity determining module 404 may determine whether the network user input is valid. If a determination is made that the network user input is invalid, an error reporting and exiting module 406 may be used to present an error message to the network user indicating that the network user input is invalid and may also exit the computer system. If, however, the network user input is valid, the system 400 may create a link list of information structures for each IP address using linked lists creating module 408. The system 400 may then insert the data based stored policy defined values into each IP addresses appropriate fields using policy value importing module 410.

The system 400 may then use the link list to determine DNS defined hosts names registered to the IP addresses using DNS gethostbyaddr calling module 412.

An internet control message protocol (ICMP) echo requests may be transmitted to each IP address in the linked list using ICMP echo request transmitting module 414. A TCP ping transmitting module 416 may be used to transmit a TCP ping to the networked systems. A TCP ping may be used in the event that a networked systems ability to respond to an ICMP echo request has been disabled. A TCP synchronization request may then be transmitted using TCP synchronization requesting module 418. After sending the TCP synchronization request, a connection determining module 420 may be used to determine whether a connection to the network system has been made. If a connection has been made, the UNIX_flag member for the computer system may be set using UNIX_flag member setting module 422.

The system 400 may then transmit a netbios name request using net bio theme transmitting module 424. Netbios name response turning module 426 may then be used to determine whether a response has been transmitted for the netbios name request. If a netbios name response has been transmitted, the netbios host name may be extracted using netbios host name extracting module 428. A user name and MAC address for the netbios response transmitting system may be determined using user name and MAC address determining module 430. The netbios_flag for the responding system may then be set using netbios_flag setting module 432.

The system 400 may then determine the operating system for the responding system using operating systems determining module 434. The system 400 may base a determination on whether a responding system is running and authentication service. If the system is running an authentication service, the responding system may be considered to be a UNIX based system. If the system is not running an authentication service, the system may be considered to be a Microsoft based system if a netbios named service protocol is running.

After a scan is completed, the result of the scan may be imported to a database using results importing module 436. Based on the results, up known hosts may be displayed using up known host displaying module 438. Stowaways may be displayed using stowaway displaying module 440. Down known hosts may be displayed using down hosts displaying module 442.

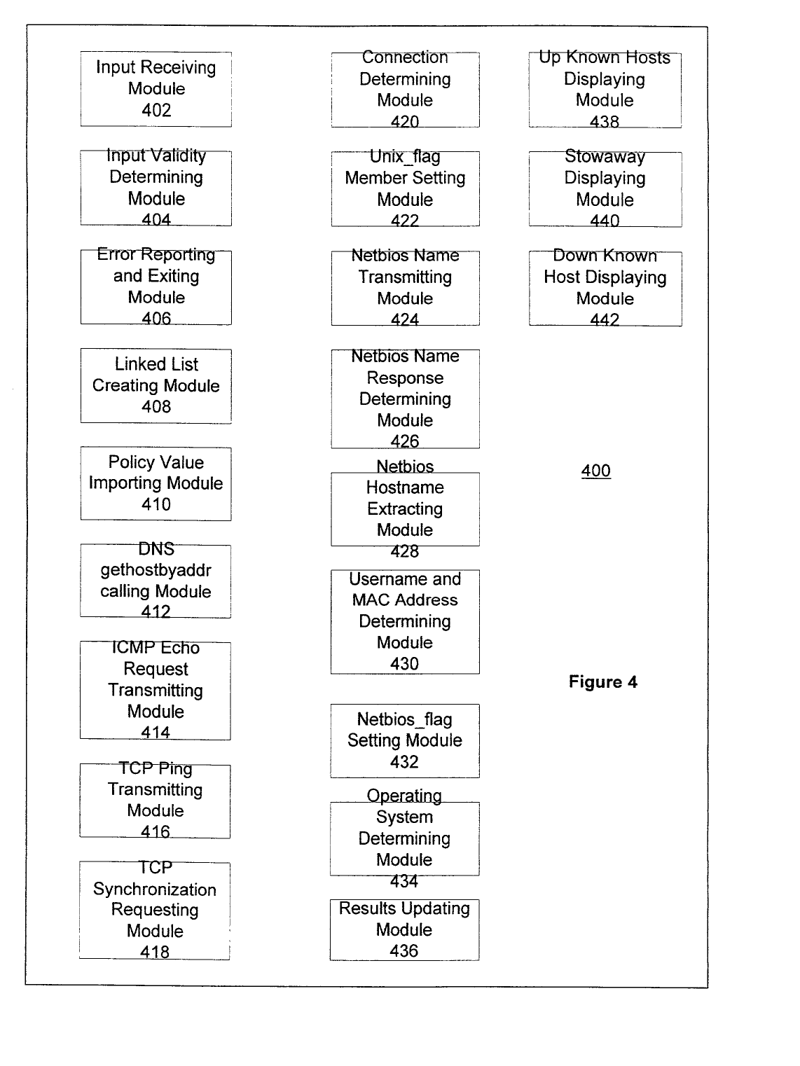

FIG. 5 illustrates a system 500 for TCP/UDP port scanning according to one embodiment of the invention. System 500 may include an input receiving module 502 that enables a user to provide input. Input validity determining module 504 may be used to determine whether the input is valid. If a determination is made that the input is invalid, an error report may be generated and the system exited using error reporting and exiting module 506. If the input is valid, however, a linked list of IP addresses may be created using linked lists creating module 508. Policy values for which each of the systems corresponding to the IP addresses must be adhered to may be imported using policy value importing module 510. An ICMP request may then be transmitted to each system corresponding to the IP addresses in the linked list using ICMP request transmitting module 512. An ICMP request response determining module 514 can then be used to determine whether any of the systems have responded to the ICMP request. Any TCP ping transmitting module 516 may be used to transmit a TCP ping to one or more of the systems corresponding to the IP addresses in the linked lists. A TCP ping response determining module 518 may be used to determine whether a response has been received for one or more of the TCP pings transmitted.

If a system responds to either the ICMP request for TCP ping, the systems to be scanned may be set using systems to be scanned setting module 520. TCP scanning may then commence using TCP scanning module 522. Upon completing the TCP scanning, the system 500 may return to the linked list using link list returning module 524. A UDP packet may then be transmitted to each port of a scanned system using UDP packet transmitting module 526. A determination may be made regarding whether one or more of the scanned systems have responded to the UDP packet using UDP packet response determining module 528. Based on a determination made by UDP packet response determining module UDP scanning may be commenced for those systems that transmitted a response using UDP scanning module 530. Upon completion of the UDP scanning, the scan results may be imported using scan results importing module 532. The scanning results may then be output and presented to a network user using scanned results outputting module 534.

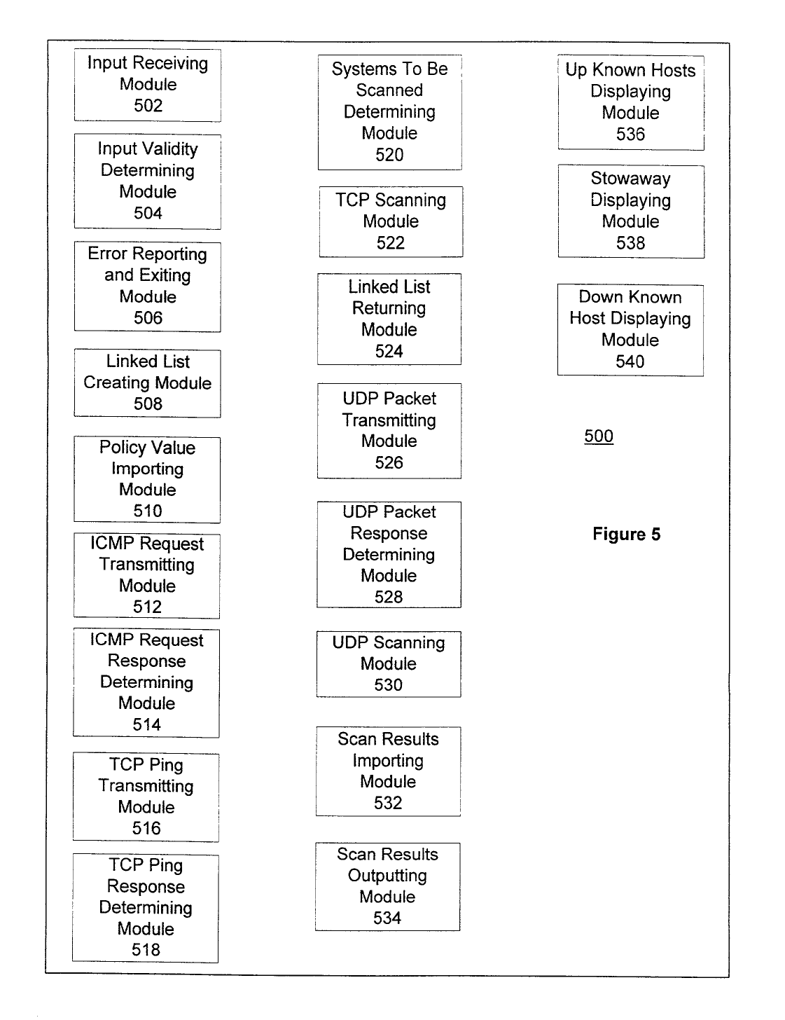

FIG. 6 illustrates a system 600 for notifying a network user of a policy amendment according to one embodiment of the invention. The system 600 may include a policy amendment creating module 602 that enables a network user to create an amendment to a network security policy. After creating the policy amendment, the network user may request that an electronic mail message be created to define other network users of the policy amendment. In the e-mail message request may be made using e-mail message requesting module 604. If a user does not request an e-mail message to be created, the policy including the policy amendment may be stored using policy storing module 606. If, however, the network user requests that an e-mail message be created, the network user may select one or more recipients to whom the e-mail message should be sent using recipient selecting module 608. The e-mail message may then be sent to the recipients using message sending module 610. The recipients may then receive the message using message receiving module 612. The e-mail message may include a uniform resource locator (URL) that may be a hypertext link that may present the policy amendment to the network user. The network user may select the URL using URL selecting module 614. If the network user selects the URL, the policy amendment may be presented to the user using policy presenting module 616. The policy may be presented in a window of a browser.

Policy presenting module 616 may present a network user with fields in which the network user may provide a user name. The user name input by the network user may be received using user name receiving module 618. An acknowledge button may also be presented to the user using policy presenting module 616. Such that after the network user reads the policy, the network user may select the acknowledge button using acknowledge button selecting module 620 to acknowledge that the network user has read the policy. System 600 may then identify a type of system that is in use by network user using system identifying module 622. The information may include, for example, operating system, network connection, etc. This information may be stored in a database using information storing module 624. A policy confirmation may then be transmitted to the network user using policy confirmation transmitting module 626.

What is claimed is:

1. A method of determining whether a networked system complies with a network security policy, the method comprising the steps of:
identifying at least one system to scan;
scanning the at least one system for current information pertaining to the at least one system;
comparing the current information obtained from the step of scanning against stored information for a network security policy pertaining to the at least one system; and
determining whether the at least one system complies with a network security policy based on the step of comparing.

2. The method of claim 1, further comprising the step of:
create a list of the at least one system to scan, wherein the list identifies the at least one system using a system identifier.

3. The method of claim 2, wherein the system identifier is an Internet Protocol (IP) address.

4. The method of claim 1, further comprising the step of:
associating at least one stored network security policy value with the system identifier.

5. The method of claim 1, further comprising the step of:
determining whether the at least one system is active.

6. The method of claim 5, further comprises the step of:
transmitting a Transmission Control Protocol (TCP) ping request.

7. The method of claim 5, further comprises the step of:
transmitting an Internet Control Message Protocol (ICMP) echo request.

8. The method of claim 1, further comprising the step of:
setting an operating system identifying flag.

9. The method of claim 8, further comprising the step of:
determining an operating system for the at least one system;

10. The method of claim 1, further comprising the step of:
importing the current information to a database.

11. The method of claim 1, wherein the current information comprises at least one of a DNS hostname, netbios hostname, netbios username, operating system, and MAC address.

12. The method of claim 1, wherein the stored information comprises at least one of a DNS hostname, netbios hostname, netbios username, operating system, and MAC address.

13. A system for determining whether a networked system complies with a network security policy, the system comprising:
an identifying module that identifies at least one system to scan;
a scanning module that scans the at least one system for current information pertaining to the at least one system;
a comparing module that compares the current information obtained from the step of scanning against stored information for a network security policy pertaining to the at least one system; and
a compliance determining module that determines whether the at least one system complies with a network security policy based on the step of comparing.

14. The system of claim 13, further comprising a list creating module that creates a list of the at least one system to scan, wherein the list identifies the at least one system using a system identifier.

15. The system of claim 14, wherein the system identifier is an Internet Protocol (IP) address.

16. The system of claim 13, further comprising an associating module that associates at least one stored network security policy value with the system identifier.

17. The system of claim 13, further comprising an active system determining module that determines whether the at least one system is active.

18. The system of claim 17, further comprising a ping transmitting module that transmits a Transmission Control Protocol (TCP) ping request.

19. The system of claim 17, further comprising an ICMP transmitting module that transmits an Internet Control Message Protocol (ICMP) echo request.

20. The system of claim 13, further comprising a setting module that sets an operating system identifying flag.

21. The system of claim 20, further comprising an operating system determining module that determines an operating system for the at least one system.

22. The system of claim 13, further comprising an importing module that imports the current information to a database.

23. The system of claim 13, wherein the current information comprises at least one of a DNS hostname, netbios hostname, netbios username, operating system, and MAC address.

24. The system of claim 13, wherein the stored information comprises at least one of a DNS hostname, netbios hostname, netbios username, operating system, and MAC address.
